(19) United States
(12) Patent Application Publication
(10) Pub. No.: US 2026/0260817 A1
(43) Pub. Date: Sep. 3, 2026

(54) MULTILAYER CERAMIC CAPACITOR

(71) Applicant: Murata Manufacturing Co., Ltd., Nagaokakyo-shi (JP)

(72) Inventor: Kazuhiro NISHIBAYASHI, Nagaokakyo-shi (JP)

(21) Appl. No.: 19/654,882

(22) Filed: Apr. 22, 2026

Related U.S. Application Data
(63) Continuation of application No. PCT/JP2024/040607, filed on Nov. 15, 2024.

(30) Foreign Application Priority Data
Apr. 9, 2024 (JP) 2024-062656

(51) Int. Cl. H01G 4/232; H01G 2/06; H01G 4/008; H01G 4/012; H01G 4/12; H01G 4/30

(52) U.S. Cl. CPC H01G 4/2325; H01G 2/065; H01G 4/008; H01G 4/012; H01G 4/12; H01G 4/30

(57) ABSTRACT

In a multilayer ceramic capacitor, an end-surface outer electrode includes an electrode body portion on an end surface and a bent portion extending from the electrode body portion in an electrode proximity direction. The bent portion includes an underlying electrode layer including Cu and includes a concave portion where a thickness of the underlying electrode layer is less than a thickness of a portion of the underlying electrode layer adjacent in the electrode proximity direction and is less than or equal to a thickness of a portion of the underlying electrode layer adjacent in an electrode separation direction, a first convex portion that is a portion of the underlying electrode layer on an electrode separation direction side relative to the concave portion, and a second convex portion that is a portion of the underlying electrode layer on an electrode proximity direction side relative to the concave portion.

### CROSS REFERENCE TO RELATED APPLICATIONS

This application claims the benefit of priority to Japanese Patent Application No. 2024-062656 filed on Apr. 9, 2024 and is a Continuation Application of PCT Application No. PCT/JP 2024/040607 filed on Nov. 15, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

There are multilayer ceramic capacitors including a multilayer body, which is formed by stacking dielectric layers and inner electrodes, and an outer electrode, which is composed of an underlying electrode layer including a metal and a plating layer. For example, in a multilayer ceramic capacitor described in Japanese Unexamined Patent Application Publication No. 2020-072246, the outer electrode is provided so as to cover an end surface and a portion of a main surface and a side surface of the multilayer body. The outer electrode has a function of reducing or preventing entry of water into the multilayer body and a function of reducing mechanical stress that acts on the multilayer body. Due to these functions, various properties of the multilayer ceramic capacitor, such as capacitance characteristics and insulation resistance, are maintained.

### SUMMARY OF THE INVENTION

However, the underlying electrode layer may cause a crack to be generated near a surface of the multilayer body due to internal stress in the metal. It is conceivable that such a problem can be addressed by, for example, forming the underlying electrode layer from a resin. However, due to moisture absorbency of the resin, such an outer electrode may be deficient in the function of reducing or preventing entry of water into the multilayer body.

Example embodiments of the present invention provide multilayer ceramic capacitors that each reduce or prevent breakage of a multilayer body while ensuring moisture resistance reliability.

A multilayer ceramic capacitor according to an example embodiment of the present invention includes a multilayer body including an inner layer portion including a plurality of dielectric layers and a plurality of inner electrodes, a first main surface and a second main surface facing each other in a stacking direction, a first side surface and a second side surface facing each other in a width direction perpendicular to the stacking direction, and a first end surface and a second end surface facing each other in a length direction perpendicular to the stacking direction and the width direction, and a pair of outer electrodes on at least either of the side surfaces or the end surfaces. When an electrode arrangement direction is defined as a direction in which the pair of outer electrodes are arranged, and, in the electrode arrangement direction, an electrode proximity direction is defined as a direction in which the pair of outer electrodes are in proximity to each other and an electrode separation direction is defined as a direction in which the pair of outer electrodes are separated from each other, each of the outer electrodes includes a connection portion on a corresponding one of the side surfaces and the end surfaces that face each other in the electrode arrangement direction, and a bent portion that extends from the connection portion in the electrode proximity direction. The bent portion includes an underlying electrode layer including Cu. The underlying electrode layer of the bent portion includes a concave portion where a thickness of the underlying electrode layer is less than a thickness of a portion of the underlying electrode layer that is adjacent in the electrode proximity direction and is less than or equal to a thickness of a portion of the underlying electrode layer that is adjacent in the electrode separation direction, a first convex portion that is a portion of the underlying electrode layer of the bent portion that is on an electrode separation direction side relative to the concave portion, and a second convex portion that is a portion of the underlying electrode layer of the bent portion that is on an electrode proximity direction side relative to the concave portion.

With example embodiments of the present invention, it is possible to provide multilayer ceramic capacitors that each reduce or prevent breakage of a multilayer body while ensuring moisture resistance reliability.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1 according to an example embodiment of the present invention.

FIG. 2 is a cross-sectional view taken along line II-II in FIG. 1.

FIG. 3 is a cross-sectional view taken along line III-III in FIG. 1.

FIG. 4 is a cross-sectional view of the multilayer ceramic capacitor 1 taken along a side-surface inner electrode 50.

FIG. 5 is an enlarged view of a portion V in FIG. 2.

FIG. 6 is an enlarged view of a portion VI in FIG. 3.

### DETAILED DESCRIPTION OF THE EXAMPLE EMBODIMENTS

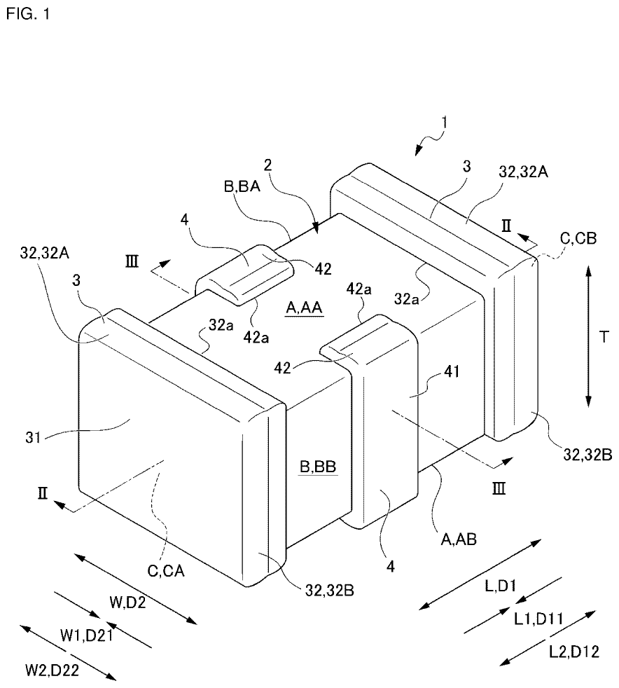

Hereafter, multilayer ceramic capacitors according to example embodiments of the present invention will be described with reference to FIGS. 1 to 6.

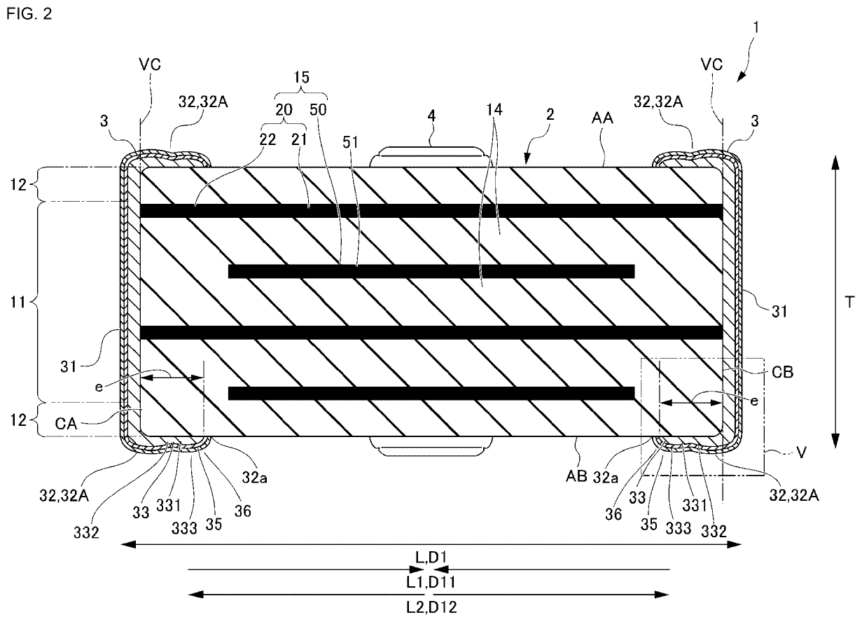

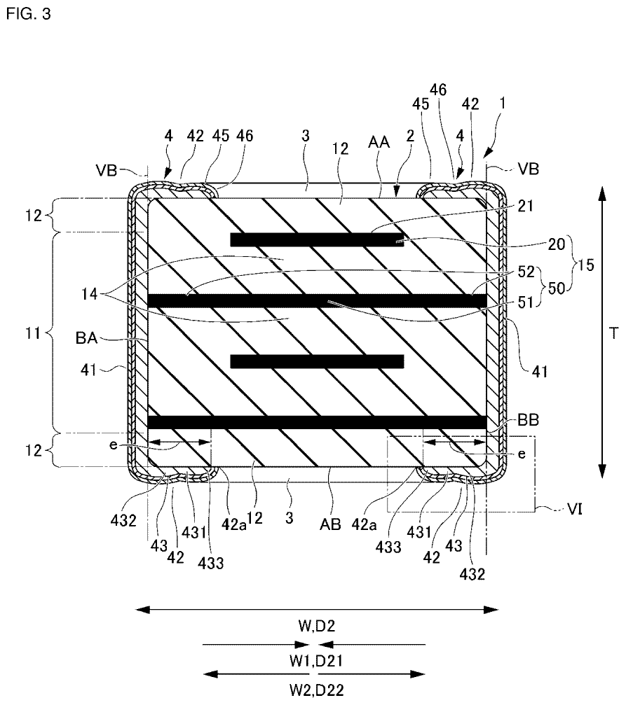

As illustrated in FIG. 1, a multilayer ceramic capacitor 1 according to a present example embodiment of the present invention is a so-called three-terminal multilayer ceramic capacitor. The multilayer ceramic capacitor 1 includes a multilayer body 2, a pair of end-surface outer electrodes 3, and a pair of side-surface outer electrodes 4. The multilayer body 2 has a substantially rectangular-parallelepiped shape and has six outer surfaces. As illustrated in FIGS. 2 and 3, the multilayer body 2 includes an inner layer portion 11 in which dielectric layers 14 and inner electrodes 15 are stacked.

In the present specification, a stacking direction T is defined as a direction in which the dielectric layers 14 and the inner electrodes 15 are stacked in the multilayer ceramic capacitor 1. A length direction L is defined as a direction that is perpendicular to the stacking direction T. A width direction W is defined as a direction that is perpendicular to both of the length direction L and the stacking direction T.

Among the six surfaces of the multilayer body 2, a first main surface AA and a second main surface AB are defined as a pair of outer surfaces that are provided on both sides in the stacking direction, a first side surface BA and a second side surface BB are defined as a pair of outer surfaces that extend in the stacking direction T and that are provided on both sides in the width direction W, and a first end surface CA and a second end surface CB are defined as a pair of outer surfaces that extend in the stacking direction T and that are provided on both sides in the length direction L. The first main surface AA and the second main surface AB may be collectively referred to as “main surfaces A”. The first side surface BA and the second side surface BB may be collectively referred to as “side surfaces B”. The first end surface CA and the second end surface CB may be collectively referred to as “end surfaces C”.

In the length direction L, “inward length direction L1” is defined as a direction from each end surface C toward a central portion of the multilayer body 2 in the length direction L, and “outward length direction L2” is defined as a direction from a central portion of the multilayer body 2 in the length direction L toward each end surface C. In the width direction W, “inward width direction W1” is defined as a direction from each side surface B toward a central portion of the multilayer body 2 in the width direction W, and “outward width direction W2” is defined as a direction from a central portion of the multilayer body 2 in the width direction W toward each side surface B.

Each of the pair of end-surface outer electrodes 3 is provided on a corresponding one of the end surfaces C. Each of the pair of side-surface outer electrodes 4 is provided on a corresponding one of the side surfaces B.

In the present specification, “electrode arrangement direction” is defined as a direction in which a pair of outer electrodes are arranged. In the electrode arrangement direction, “electrode proximity direction” is defined as a direction in which a pair of outer electrodes are in proximity to each other, and “electrode separation direction” is defined as a direction in which a pair of outer electrodes are separated from each other. “Electrode arrangement direction D1” is defined as the electrode arrangement direction of the end-surface outer electrodes 3, “electrode proximity direction D11” is defined as the electrode proximity direction of the end-surface outer electrodes 3, and “electrode separation direction D12” is defined as the electrode separation direction of the end-surface outer electrodes 3.

“Electrode arrangement direction D2” is defined as the electrode arrangement direction of the side-surface outer electrodes 4, “electrode proximity direction D21” is defined as the electrode proximity direction of the side-surface outer electrodes 4, and “electrode separation direction D22” is defined as the electrode separation direction of the side-surface outer electrodes 4.

The electrode arrangement direction D1 of the end-surface outer electrodes 3 is the length direction L. In describing the end-surface outer electrodes 3, the electrode proximity direction D11 is the inward length direction L1, and the electrode separation direction D12 is the outward length direction L2.

The electrode arrangement direction D2 of the side-surface outer electrodes 4 is the width direction W. In describing the side-surface outer electrodes 4, the electrode proximity direction D21 is the inward width direction W1, and the electrode separation direction D22 is the outward width direction W2.

“LT cross section” is defined as a cross section of the multilayer body 2 parallel to the length direction L and the stacking direction T. “WT cross section” is defined as a cross section of the multilayer body 2 parallel to the width direction W and the stacking direction T. “LW cross section” is defined as a cross section of the multilayer body 2 parallel to the length direction L and the width direction W.

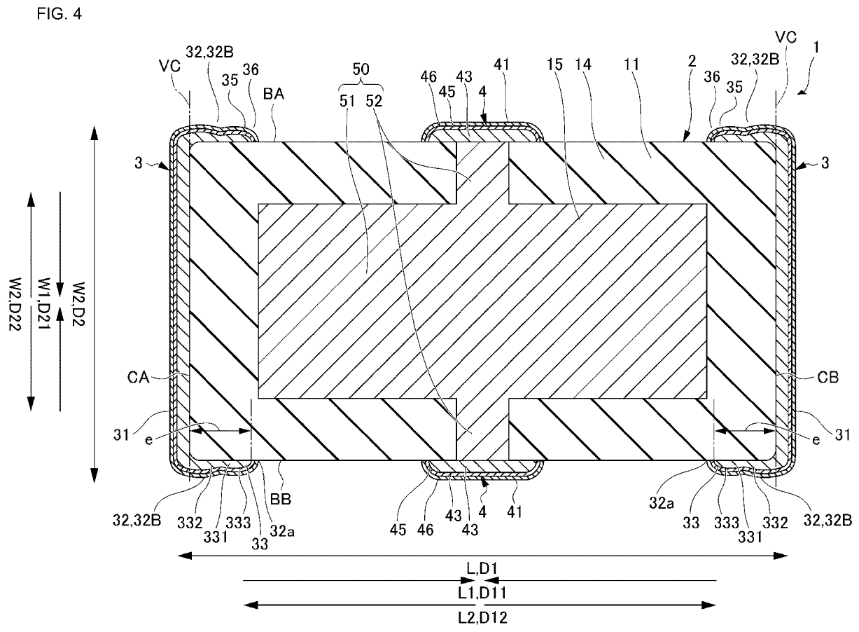

FIG. 2 illustrates an LT cross section that passes through a central portion of the multilayer body 2 in the width direction W. FIG. 3 illustrates a WT cross section that passes through a central portion of the multilayer body 2 in the length direction L. FIG. 4 illustrates an LW cross section taken along an inner electrode 15 (to be specific, a side-surface inner electrode 50 described below).

The multilayer body 2 includes the inner layer portion 11 and a pair of outer layer portions 12 that are disposed with the inner layer portion 11 therebetween in the stacking direction T. It is preferable that corner portions and ridge portions of the multilayer body 2 be rounded. A corner portion is a portion where three surfaces of the multilayer body intersect. A ridge portion is a portion where two surfaces of the multilayer body intersect.

As illustrated in FIGS. 2 and 3, the inner layer portion 11 includes a plurality of dielectric layers 14 and a plurality of inner electrodes 15. The dielectric layers 14 and the inner electrodes 15 are alternately stacked.

Each dielectric layer 14 is made of, for example, dielectric ceramic whose main component is BaTiO₃. The dielectric ceramic may include a Mn compound, an Fe compound, a Cr compound, a Co compound, a Ni compound, or the like as an accessory material.

Each inner electrode 15 is made of, for example, a metal material such as Ni, Cu, Sn, Ag, Pd, Ag-Pd alloy, Au, or the like. The inner electrodes 15 include a plurality of end-surface inner electrode 20 and a plurality of side-surface inner electrodes 50. The end-surface inner electrodes 20 and the side-surface inner electrodes 50 are alternately arranged in the stacking direction T. The end-surface inner electrodes 20 and the side-surface inner electrodes 50 may be collectively referred to as “inner electrodes 15”.

Each end-surface inner electrode 20 extends between both end surfaces C of the multilayer body 2 in the length direction L. Each end portion of the end-surface inner electrode 20 in the length direction L is exposed on a corresponding one of the end surfaces C. The end-surface inner electrode 20 is separated from both side surfaces B in the width direction W by a certain distance. The end-surface inner electrode 20 includes a first facing portion 21 and two first lead-out portions 22.

The first facing portion 21 is a portion of the end-surface inner electrode 20 that faces the side-surface inner electrode 50 that is adjacent in the stacking direction T. The first facing portion 21 is located in a central portion between the end surfaces C. Each first lead-out portion 22 is a portion of the end-surface inner electrode 20 that is led out from the first facing portion 21 toward a corresponding one of the end surfaces C. Each first lead-out portion 22 is exposed on a corresponding one of the end surfaces C.

As illustrated in FIG. 4, each end portion of the side-surface inner electrode 50 in the width direction W is exposed on a corresponding one of the side surfaces B. The side-surface inner electrode 50 is separated from both end surfaces C in the length direction L by a certain distance. The side-surface inner electrode 50 includes a second facing portion 51 and two second lead-out portions 52.

The second facing portion 51 is a portion of the side-surface inner electrode 50 that faces the end-surface inner electrode 20 that is adjacent in the stacking direction T. The second facing portion 51 is located in a central portion between the side surfaces B. Each second lead-out portion 52 is a portion of the side-surface inner electrode 50 that is led out from the second facing portion 51 toward a corresponding one of the side surfaces B. Each second facing portion 51 is exposed on a corresponding one of the side surfaces B.

The first facing portion 21 and the second facing portion 51 may be collectively referred to as “facing portions 21 and 51”. The first lead-out portions 22 and the second lead-out portions 52 may be collectively referred to as “lead-out portions 22 and 52”.

When the inner electrode 15 includes Sn, electric field concentration on the interface between the inner electrode 15 and the dielectric layer 14 can be alleviated, and thus high-temperature load reliability can be improved. In this case, Sn can sufficiently provide the advantageous effect even when Sn is included only in the end-surface inner electrode 20 or only in the side-surface inner electrode 50.

Each outer layer portion 12 may be made of the same material as the dielectric layer 14 of the inner layer portion 11. The inner electrode 15 is not disposed in the outer layer portion 12.

Each end-surface outer electrode 3 is disposed on a corresponding one of the end surfaces C of the multilayer body 2. To each end-surface outer electrode 3, a corresponding one of the first lead-out portions 22 is connected. Each end-surface outer electrode 3 covers not only the end surface C but also a portion of the main surface A and a portion of the side surface B adjacent to the end surface C. Each end-surface outer electrode 3 includes an electrode body portion 31 that is disposed on a corresponding one of the end surfaces C and a bent portion 32 that extends from the electrode body portion 31 in the electrode proximity direction D11 (the inward length direction L1).

The electrode body portion 31 is disposed on the end surface C. The electrode body portion 31 is connected to the end-surface inner electrodes 20. The bent portion 32 is disposed on the main surface A and on the side surface B. To be more specific, when “imaginary plane VC” is defined as an imaginary plane that is an extension of the end surface C in the stacking direction T and the width direction W, the electrode body portion 31 is a portion of the end-surface outer electrode 3 that is on the electrode separation direction D12 side relative the imaginary plane VC, and the bent portion 32 is a portion of the end-surface outer electrode 3 that is on the electrode proximity direction D11 side relative to the imaginary plane VC.

An end portion of the bent portion 32 in the electrode proximity direction D11 may be referred to as “bent edge portion 32a”. A portion of the bent portion 32 that extends from the electrode body portion 31 onto the main surface A may be referred to as “main-surface bent portion 32A”, and a portion of the bent portion 32 that extends from the electrode body portion 31 onto the side surface B may be referred to as “side-surface bent portion 32B”.

The bent portion 32 has, for example, a substantially quadrangular tubular shape. The main-surface bent portion 32A extends over the entire area in the width direction W of an edge portion of the main surface A adjacent to the end surface C. The side-surface bent portion 32B extends over the entire area in the height direction T of an edge portion of the side surface B adjacent to the end surface C. The main-surface bent portion 32A and the side-surface bent portion 32B are continuous with each other.

However, the configuration of the bent portion 32 is not limited to this. For example, the main-surface bent portion 32A need not extend over the entire area in the width direction W of the edge portion of the main surface A adjacent to the end surface C. The side-surface bent portion 32B need not extend over the entire area in the height direction T of the edge portion of the side surface B adjacent to the end surface C. The bent portion 32 may be disposed on at least one of the main surfaces A and the side surfaces B, and need not be disposed on all of the main surfaces A and the side surfaces B.

The end-surface outer electrode 3 includes an underlying electrode layer 33 that is in contact with a surface of the multilayer body 2, a first plating layer 35 that is disposed on the underlying electrode layer 33, and a second plating layer 36 that is disposed on the first plating layer 35. The electrode body portion 31 and the bent portion 32 each include the underlying electrode layer 33, the first plating layer 35, and the second plating layer 36.

The underlying electrode layer 33 is, for example, a baked layer including a conductive metal, such as Cu (copper), and glass. The first plating layer 35 is, for example, a Ni (nickel) plating layer. The second plating layer 36 is, for example, a Sn (tin) plating layer.

The first plating layer 35 and the second plating layer 36 each have a substantially uniform thickness. Therefore, the outer surface of the end-surface outer electrode 3 has substantially the same shape as the outer surface of the underlying electrode layer 33.

Each side-surface outer electrode 4 is disposed on a corresponding one of the side surfaces B of the multilayer body 2. To each side-surface outer electrode 4, a corresponding one of the second lead-out portions 52 is connected. Each side-surface outer electrode 4 covers not only a portion of the side surface B but also a portion of the main surface A adjacent to the side surface B. Each side-surface outer electrode 4 includes an electrode body portion 41 that is disposed on a corresponding one of the side surfaces B and a bent portion 42 that extends from the electrode body portion 41 in the electrode proximity direction D21 (the inward width direction W1).

The electrode body portion 41 is disposed on the side surface B. The electrode body portion 41 is connected to the side-surface inner electrodes 50. The bent portion 42 is disposed on the main surface A. To be more specific, when “imaginary plane VB” is defined as an imaginary plane that is an extension of the side surface B in the stacking direction T and the length direction L, the electrode body portion 41 is a portion of the side-surface outer electrode 4 that is on the electrode separation direction D22 side relative to the imaginary plane VB, and the bent portion 42 is a portion of the side-surface outer electrode 4 that is on the electrode proximity direction D21 side relative to the imaginary plane VB. The bent portion 42 is disposed, for example, on each of the main surfaces A. An edge portion of the bent portion 42 in the electrode proximity direction D21 may be referred to as “bent edge portion 42a”.

Each side-surface outer electrode 4 includes an underlying electrode layer 43 that is in contact with a surface of the multilayer body 2, a first plating layer 45 that is disposed on the underlying electrode layer 43, and a second plating layer 46 that is disposed on the first plating layer 45. The electrode body portion 41 and the bent portion 42 each include the underlying electrode layer 43, the first plating layer 45, and the second plating layer 46.

The underlying electrode layer 43 is, for example, a baked layer including a conductive metal, such as Cu, and glass. The first plating layer 45 is, for example, a Ni plating layer. The second plating layer 46 is, for example, a Sn plating layer.

The first plating layer 45 and the second plating layer 46 each have a substantially uniform thickness. Therefore, the outer surface of the side-surface outer electrode 4 has substantially the same shape as the outer surface of the underlying electrode layer 43.

The end-surface outer electrodes 3 and the side-surface outer electrodes 4 may be collectively referred to as “outer electrodes 3 and 4”. The electrode body portion 31 and the electrode body portion 41 may be collectively referred to as “electrode body portions 31 and 41”. The bent portion 32 and the bent portion 42 may be collectively referred to as “bent portions 32 and 42”. The bent edge portion 32a and the bent edge portion 42a may be collectively referred to as “bent edge portions 32a and 42a”. The underlying electrode layer 33 and the underlying electrode layer 43 may be collectively referred to as “underlying electrode layers 33 and 43”. The first plating layer 35 and the first plating layer 45 may be collectively referred to as “first plating layers 35 and 45”. The second plating layer 36 and the second plating layer 46 may be collectively referred to as “second plating layers 36 and 46”.

In the present specification, the shortest distance from a point on a lower surface of the outer electrodes 3 and 4 (joint surface with the multilayer body 2) to an outer surface of the outer electrodes 3 and 4 (surface separated from the multilayer body 2) is defined as the thickness of the outer electrodes 3 and 4 at the point. The shortest distance from a point on a lower surface of the underlying electrode layers 33 and 43 (joint surface with the multilayer body 2) to an outer surface of the underlying electrode layers 33 and 43 (joint surface with the first plating layers 35 and 45) is defined as the thickness of the underlying electrode layers 33 and 43 at the point. The shortest distance from a point on a lower surface of the first plating layers 35 and 45 (joint surface with the underlying electrode layers 33 and 43) to an outer surface of the first plating layers 35 and 45 (joint surface with the second plating layers 36 and 46) is defined as the thickness of the first plating layers 35 and 45 at the point. The shortest distance from a point on a lower surface of the second plating layers 36 and 46 (joint surface with the first plating layers 35 and 45) to an outer surface of the second plating layers 36 and 46 (outer surface of the outer electrodes 3 and 4) is defined as the thickness of the second plating layers 36 and 46 at the point.

In the multilayer ceramic capacitor 1, the underlying electrode layers 33 and 43, which include a metal (to be specific, Cu), are respectively provided in the outer electrodes 3 and 4. Therefore, the outer electrodes 3 and 4 can effectively reduce or prevent entry of water into the multilayer body 2. Thus, it is possible to ensure the moisture resistance reliability of the multilayer ceramic capacitor 1.

However, when the outer electrodes 3 and 4 include the underlying electrode layers 33 and 43, which include a metal, a crack may be easily generated near a surface of the multilayer body 2 due to internal stress in the metal of the underlying electrode layers 33 and 43. There is a concern that such a crack may be generated particularly in a portion of the multilayer body 2 in contact with the bent edge portions 32a and 42a.

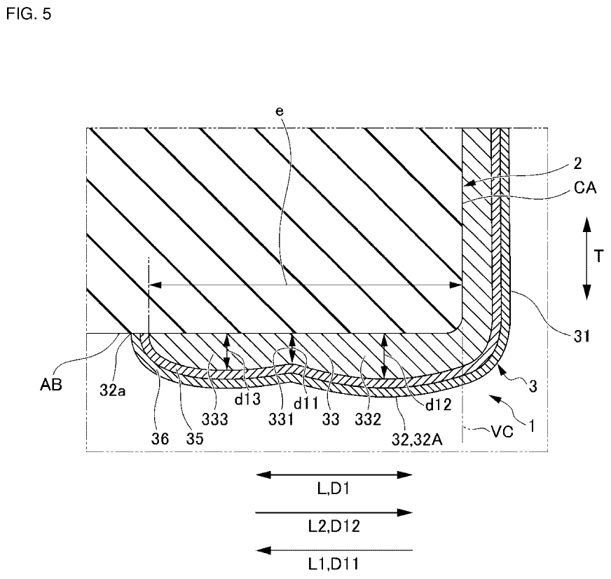

For this reason, as illustrated in FIG. 5, in the end-surface outer electrode 3, the underlying electrode layer 33 of the bent portion 32 includes a concave portion 331 that is a portion where the thickness of the underlying electrode layer 33 is less than the thickness of a portion of the underlying electrode layer 33 that is adjacent on the electrode proximity direction D11 side and is less than or equal to the thickness of a portion of the underlying electrode layer 33 that is adjacent on the electrode separation direction D12 side, a first convex portion 332 that is a portion of the underlying electrode layer 33 of the bent portion 32 that is on the electrode separation direction D12 side relative to the concave portion 331, and a second convex portion 333 that is a portion of the underlying electrode layer 33 of the bent portion 32 that is on the electrode proximity direction D11 side relative to the concave portion 331.

To be more specific, in the end-surface outer electrode, the outer surface of the underlying electrode layer 33 of the bent portion 32 has, for example, a concave/convex shape such that two arcs that are convex in a direction away from the multilayer body 2 are adjacent to each other in the electrode arrangement direction D1. The outer surface of the first convex portion 332 and the outer surface of the second convex portion 333 each have an arc shape that is convex in a direction away from the multilayer body 2. The concave portion 331 is the boundary portion between the first convex portion 332 and the second convex portion 333.

With the above configuration, because it is possible to concentrate stress of the first convex portion 332 on the concave portion 331, it is possible to reduce or prevent transmission of stress of the first convex portion 332 to the bent edge portion 32a. Thus, because stress of the bent edge portion 32a can be reduced, it is possible to reduce stress that acts on a portion of the multilayer body 2 in contact with the bent edge portion 32a. Therefore, it is possible to reduce or prevent breakage of the multilayer body 2 due to stress of the end-surface outer electrodes 3.

It is conceivable that a region near an edge of the bent portion 32 may break comparatively easily. However, with the above configuration, the thickness of the second convex portion 333 is greater than the thickness of the concave portion 331. In this case, because it is possible to maintain the thickness of the second convex portion 333 to be greater than or equal to a certain level, it is possible to ensure the strength of a portion near the edge of the bent portion 32. Thus, it is possible to reduce or prevent breakage of the outer electrode 3.

In FIG. 5, the thickness of the concave portion 331 is denoted by “d11”, the thickness of the thickest portion of the first convex portion 332 is denoted by “d12”, and the thickness of the thickest portion of the second convex portion 333 is denoted by “d13”. In FIG. 5, illustration of the structure of the inside of the multilayer body 2 is omitted.

The shape of the outer surface of the underlying electrode layer 33 disposed on each main surface A and the shape of the outer surface of the underlying electrode layer 33 disposed on each side surface B are substantially corresponding shapes. Therefore, detailed illustration of the shape of the outer surface of the underlying electrode layer 33 disposed on each side surface B is omitted.

Moreover, the thickness of the concave portion 331 is less than or equal to about ¾ of the thickness of the thickest portion of the first convex portion 332, for example, within manufacturing and measurement tolerances.

With the above configuration, because it is possible to more appropriately concentrate stress of the first convex portion 332 on the concave portion 331, it is possible to more effectively reduce or prevent transmission of stress to the bent edge portion 32a.

The thickness of the thickest portion of the second convex portion 333 is less than the thickness of the thickest portion of the first convex portion 332.

Because the second convex portion 333 is located closer than the concave portion 331 to the bent edge portion 32a, it is conceivable that stress of the second convex portion 333 is comparatively easily transmitted to the bent edge portion 32a even when the concave portion 331 is provided in the underlying electrode layer 33. However, with the above configuration, it is possible to reduce stress of the second convex portion 333 by reducing the thickness of the second convex portion 333. Thus, it is possible to reduce transmission of stress to the bent edge portion 32a.

The concave portion 331 is provided at a position such that the separation distance from an end portion of the bent portion 32 in the electrode separation direction D12 is in the range of about ½e to about 9/10e, where e is the dimension of the underlying electrode layer 33 of the bent portion 32 in the electrode arrangement direction D1, for example, within manufacturing and measurement tolerances.

With the above configuration, in the bent portion 32, it is possible to make the position of the concave portion 331 close to the bent edge portion 32a. Therefore, it is possible to allow the concave portion 331 to receive a larger proportion of the stress of the entirety of the bent portion 32. Thus, it is possible to more effectively reduce or prevent transmission of stress to the bent edge portion 32a.

The thickness of the concave portion 331 is greater than or equal to about 0.5 μm, for example, within manufacturing and measurement tolerances.

While it is conceivable that stress concentrates on the concave portion 331 comparatively easily, with the above configuration, it is possible to ensure the strength of the concave portion 331. Accordingly, in the end-surface outer electrode 3, it is possible to ensure the strength of the bent portion 32.

The thickness of the first convex portion 332 is less than or equal to about 75 μm, for example, within manufacturing and measurement tolerances.

With the above configuration, because it is possible to make the thickness of the bent portion 32 comparatively small, it is possible to reduce or prevent increase in the height of the multilayer ceramic capacitor 1.

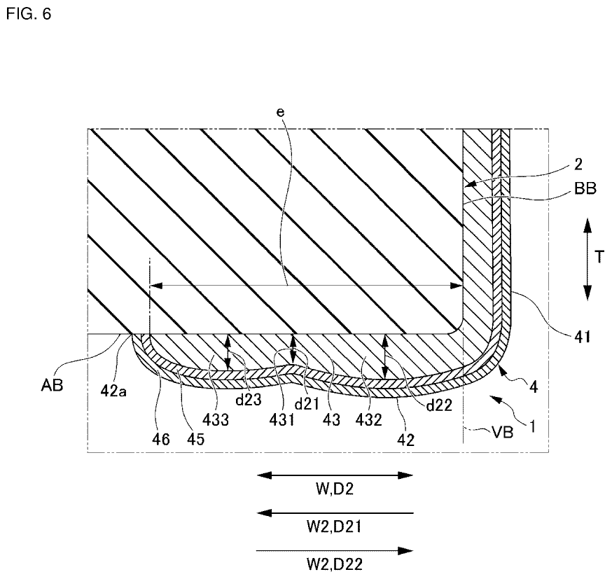

As illustrated in FIG. 6, in the side-surface outer electrode 4, the underlying electrode layer 43 of the bent portion 42 includes a concave portion 431 that is a portion where the thickness of the underlying electrode layer 43 is less than the thickness of a portion of the underlying electrode layer 43 that is adjacent on the electrode proximity direction D21 side and is less than or equal to the thickness of a portion of the underlying electrode layer 43 that is adjacent on the electrode separation direction D22 side, a first convex portion 432 that is a portion of the underlying electrode layer 43 of the bent portion 42 that is on the electrode separation direction D22 side relative to the concave portion 431, and a second convex portion 433 that is a portion of the underlying electrode layer 43 of the bent portion 42 that is on the electrode proximity direction D21 side relative to the concave portion 431.

To be more specific, in the side-surface outer electrode 4, the outer surface of the underlying electrode layer 43 of the bent portion 42 has, for example, a concave/convex shape such that two arcs that are convex in a direction away from the multilayer body 2 are adjacent to each other in the electrode arrangement direction D2. The outer surface of the first convex portion 432 and the outer surface of the second convex portion 433 each have an arc shape that is convex in a direction away from the multilayer body 2. The concave portion 431 is the boundary portion between the first convex portion 432 and the second convex portion 433.

With the above configuration, because it is possible to concentrate stress of the first convex portion 432 on the concave portion 431, it is possible to reduce or prevent transmission of stress of the first convex portion 432 to the bent edge portion 42a. Thus, because stress of the bent edge portion 42a can be reduced, it is possible to reduce stress that acts on a portion of the multilayer body 2 in contact with the bent edge portion 42a. Therefore, it is possible to reduce or prevent breakage of the multilayer body 2 due to stress of the side-surface outer electrodes 4. Accordingly, it is possible to provide the multilayer ceramic capacitor 1 that can reduce or prevent breakage of the multilayer body 2 while ensuring moisture resistance reliability.

It is conceivable that a region near an edge of the bent portion 42 may break comparatively easily. However, with the above configuration, the thickness of the second convex portion 433 is greater than the thickness of the concave portion 431. In this case, because it is possible to maintain the thickness of the second convex portion 433 to be greater than or equal to a certain level, it is possible to ensure the strength of a portion near the edge of the bent portion 42. Thus, it is possible to reduce or prevent breakage of the side-surface outer electrode 4.

In FIG. 6, the thickness of the concave portion 431 is denoted by “d21”, the thickness of the thickest portion of the first convex portion 432 is denoted by “d22”, and the thickness of the thickest portion of the second convex portion 433 is denoted by “d23”. In FIG. 6, illustration of the structure of the inside of the multilayer body 2 is omitted.

The thickness of the concave portion 431 is preferably less than or equal to about ¾ of the thickness of the thickest portion of the first convex portion 432, for example, within manufacturing and measurement tolerances.

With the above configuration, because it is possible to more appropriately concentrate stress of the first convex portion 432 on the concave portion 431, it is possible to more effectively reduce or prevent transmission of stress to the bent edge portion 42a.

Moreover, the thickness of the thickest portion of the second convex portion 433 is less than the thickness of the thickest portion of the first convex portion 432.

Because the second convex portion 433 is located closer than the concave portion 431 to the bent edge portion 42a, it is conceivable that stress of the second convex portion 433 is comparatively easily transmitted to the bent edge portion 42a even when the concave portion 431 is provided in the underlying electrode layer 43. However, with the above configuration, it is possible to reduce stress of the second convex portion 433 by reducing the thickness of the second convex portion 433. Thus, it is possible to reduce transmission of stress to the bent edge portion 42a.

The concave portion 431 is provided at a position such that the separation distance from an end portion of the bent portion 42 in the electrode separation direction D22 is in the range of about ½e to about 9/10e, where e is the dimension of the underlying electrode layer 43 of the bent portion 42 in the electrode arrangement direction D1, for example, within manufacturing and measurement tolerances.

With the above configuration, in the bent portion 42, it is possible to make the position of the concave portion 431 close to the bent edge portion 42a. Therefore, it is possible to allow the concave portion 431 to receive a larger proportion of the stress of the entirety of the bent portion 42. Thus, it is possible to more effectively reduce or prevent transmission of stress to the bent edge portion 42a.

The thickness of the concave portion 431 is greater than or equal to about 0.5 μm, for example, within manufacturing and measurement tolerances.

While it is conceivable that stress concentrates on the concave portion 431 comparatively easily, with the above configuration, it is possible to ensure the strength of the concave portion 431. Accordingly, in the side-surface outer electrode 4, it is possible to ensure the strength of the bent portion 42.

The thickness of the first convex portion 432 is less than or equal to about 75 μm, for example, within manufacturing and measurement tolerances.

With the above configuration, because it is possible to make the thickness of the bent portion 42 comparatively small, it is possible to reduce or prevent increase in the height of the multilayer ceramic capacitor 1.

Examples of a method of measuring the thickness of the outer electrodes 3 and 4 and the thickness of the underlying electrode layers 33 and 43 include a method of observing a cross section of the multilayer ceramic capacitor 1, which is exposed by polishing, by using a scanning electron microscope.

A cross section of the end-surface outer electrode 3 to be observed is, for example, an LT cross section passing through a central portion of the multilayer body 2 in the width direction W in a case of measuring the thickness of the main-surface bent portion 32A, or an LW cross section passing through a central portion of the multilayer body 2 in the stacking direction T in a case of measuring the thickness of the side-surface bent portion 32B. A cross section of the side-surface outer electrode 4 to be observed is, for example, a WT cross section passing through a central portion of the multilayer body 2 in the length direction L.

Next, a non-limiting example of a method of manufacturing the multilayer ceramic capacitor 1 according to the present example embodiment will be described.

First, ceramic green sheets, which are formed by molding ceramic slurry into a sheet-like shape, are prepared. Next, patterns of the end-surface inner electrodes 20 and the side-surface inner electrodes 50 are printed on the ceramic green sheets by using a conductive paste. Thus, ceramic green sheets on which the end-surface inner electrodes 20 are disposed and ceramic green sheets on which the side-surface inner electrodes 50 are disposed are obtained. The patterns of the end-surface inner electrodes 20 and the side-surface inner electrodes 50 are formed, for example, by using a printing method such as screen printing, gravure printing, relief printing, or the like.

Next, the ceramic green sheets on which the end-surface inner electrodes 20 are disposed and the ceramic green sheets on which the side-surface inner electrodes 50 are disposed are stacked. Next, on both sides in the stacking direction T of the stacked ceramic green sheets, ceramic green sheets for outer layer portions, which are to become the outer layer portions 12, are stacked. The ceramic green sheets for outer layer portions are thermocompression-bonded to the ceramic green sheets. Thus, a mother block is obtained.

Each outer layer portion 12 may be a stack of a plurality of ceramic green sheets or may be a single ceramic green sheet. The ceramic green sheets for inner layer portions and the ceramic green sheets for outer layer portions may include different components.

Next, the mother block is divided along cutting lines corresponding to the size of a multilayer body. The mother block is cut, for example, in the length direction L and the width direction W. Thus, a plurality of rectangular-parallelepiped blocks (referred to as “multiplayer chips”) are obtained. It is preferable that corner portions and ridge portions of the multilayer chips be rounded by, for example, barrel polishing.

Next, the multilayer chips are heated at a predetermined firing temperature in a nitrogen atmosphere. Thus, the multilayer body 2 is obtained.

Next, a conductive paste including copper and glass is applied to each side surface B of the multilayer body 2. Thus, the underlying electrode layer 43 of the side-surface outer electrode 4 is formed on each side surface B. Each underlying electrode layer 43 is formed so as to cover not only the side surface B but also a portion of the main surface A adjacent to the side surface B.

At this time, the conductive paste for the underlying electrode layer 43 is applied, for example, twice. When the conductive paste is to be applied for the second time, the conductive paste is applied onto the main surface A and the side surface B so that the position of an end portion of the conductive paste disposed on the main surface A and the side surface B is closer to each end surface C than when the conductive paste was applied for the first time. Thus, a step is formed near an end portion in the electrode proximity direction D21 of the conductive paste applied for the second time. As drying of the conductive paste progresses, a portion of the conductive paste on the electrode proximity direction D21 side relative the step and a portion of the conductive paste on the electrode separation direction D22 side relative to the step each bulge around a central portion thereof in the electrode arrangement direction D2. Thus, in the underlying electrode layer 43 of the bent portion 42, the concave portion 431 is formed at a portion where the step of the conductive paste was formed, and the first convex portion 432 and the second convex portion 433 are formed with the concave portion 431 therebetween. The first convex portion 432, where the conductive paste was applied twice, is more convex than the second convex portion 433.

It is possible to adjust the degree of bulging of portions to become the first convex portion 432 and the second convex portion 433 by, for example, adjusting the viscosity of the conductive paste. By increasing the viscosity of the conductive paste, it is possible to increase the degree of bulging of the conductive paste after being dried. Therefore, for example, the viscosity of the conductive paste to be applied for the first time is made lower than the viscosity of the conductive paste to be applied for the second time. Thus, it becomes easy to make the thickness of the second convex portion 433 small compared with the thickness of the first convex portion 432.

A method of forming the concave portion, the first convex portion, the second convex portion, and the like is not limited to this. For example, even when the conductive paste is applied only once, by shaping the surface of the conductive paste applied to the multilayer body by using a blade or the like, it is possible to form the concave portion, the first convex portion, the second convex portion, and the like in the underlying electrode layer of the bent portion.

Next, a conductive paste is applied to each end surface C of the multilayer body 2. Thus, the underlying electrode layer 33 of the end-surface outer electrode 3 is formed on each end surface C. Each underlying electrode layer 33 is formed so as to cover not only the end surface C but also a portion of the main surface A adjacent to the side surface C. At this time, the conductive paste to become the underlying electrode layer 33 is applied, for example, twice in the same way as in the case of the underlying electrode layer 43. Thus, in the underlying electrode layer 33 of the bent portion 32, the concave portion 331, the first convex portion 332, and the second convex portion 333 are formed.

Next, the multilayer body 2, in which the underlying electrode layer 33 and the underlying electrode layer 43 are formed, is heated for a predetermined time at a predetermined firing temperature in a nitrogen atmosphere. Thus, the underlying electrode layer 33 and the underlying electrode layer 43 are baked on the multilayer body 2.

Next, the first plating layer 35, which is a Ni plating layer, is formed on the underlying electrode layer 33, and the first plating layer 45, which is a Ni plating layer, is formed on the underlying electrode layer 43. The first plating layer 35 and the first plating layer 45 are formed, for example, by using a barrel plating method. Next, the second plating layer 36, which is a Sn plating layer, is formed on the first plating layer 35, and the second plating layer 46, which is a Sn plating layer, is formed on the first plating layer 45. The second plating layer 36 and the second plating layer 46 are formed, for example, by using a barrel plating method. Thus, the end-surface outer electrodes 3 and the side-surface outer electrodes 4 are formed on the multilayer body 2.

Through the above process, the multilayer ceramic capacitor 1 illustrated in FIG. 1 is obtained.

With the present example embodiment, the following advantages effects can be obtained.

In the present example embodiment, the bent portion 32 of the end-surface outer electrode 3 includes the underlying electrode layer 33 including Cu. The underlying electrode layer 33 of the bent portion 32 includes the concave portion 331 where the thickness of the underlying electrode layer 33 is less than the thickness of a portion of the underlying electrode layer 33 that is adjacent in the electrode proximity direction D11 and is less than or equal to the thickness of a portion of the underlying electrode layer 33 that is adjacent in the electrode separation direction D12, the first convex portion 332 that is a portion of the underlying electrode layer 33 of the bent portion 32 that is on the electrode separation direction D12 side relative the concave portion 331, and the second convex portion 333 that is a portion of the underlying electrode layer 33 of the bent portion that is on the electrode proximity direction D11 side relative to the concave portion 331.

The bent portion 42 of the side-surface outer electrode 4 includes the underlying electrode layer 43 including Cu. The underlying electrode layer 43 of the bent portion 42 includes the concave portion 431 where the thickness of the underlying electrode layer 43 is less than the thickness of a portion of the underlying electrode layer 43 that is adjacent in the electrode proximity direction D21 and is less than or equal to the thickness of a portion the underlying electrode layer 43 that is adjacent in the electrode separation direction D22, the first convex portion 432 that is a portion of the underlying electrode layer 43 of the bent portion 42 that is on the electrode separation direction D22 side relative to the concave portion 431, and the second convex portion 433 that is a portion of the underlying electrode layer 43 of the bent portion 42 that is on the electrode proximity direction D21 side relative to the concave portion 431.

With the above configuration, because it is possible to concentrate stress of the first convex portions 332 and 432, which are located in the electrode separation direction relative to the concave portions 331 and 431, on the concave portions 331 and 431, it is possible to reduce or prevent transmission of stress to the bent edge portions 32a and 42a. Therefore, it is possible to reduce or prevent transmission of stress to a portion of the multilayer body 2 in contact with the bent edge portions 32a and 42a. Thus, it is possible to reduce or prevent breakage of the multilayer body 2 due to stress of the outer electrodes 3 and 4.

Accordingly, it is possible to provide the multilayer ceramic capacitor 1 that can reduce or prevent breakage of the multilayer body 2 while ensuring moisture resistance reliability.

It is conceivable that a region near an edge of the bent portions 32 and 42 may break comparatively easily. However, the thicknesses of the second convex portions 333 and 433 are greater than the thicknesses of the concave portions 331 and 431. In this case, because it is possible to maintain the thicknesses of the second convex portions 333 and 433 at a certain level or greater, it is possible to ensure the strength of a portion near the edge of the bent portions 32 and 42. Thus, it is possible to reduce or prevent breakage of the outer electrodes 3 and 4.

In the present example embodiment, in the end-surface outer electrode 3, the thickness of the concave portion 331 is less than or equal to about ¾ of the thickness of the thickest portion of the first convex portion 332, for example, within manufacturing and measurement tolerances.

Moreover, in the side-surface outer electrode 4, the thickness of the concave portion 431 is less than or equal to about ¾ of the thickness of the thickest portion of the first convex portion 432, for example, within manufacturing and measurement tolerances.

With the above configuration, because it is possible to more appropriately concentrate stress of the first convex portions 332 and 432 on the concave portions 331 and 431, it is possible to more effectively reduce or prevent transmission of stress to the bent edge portions 32a and 42a.

In the present example embodiment, in the end-surface outer electrode 3, the thickness of the thickest portion of the second convex portion 333 is less than the thickness of the thickest portion of the first convex portion 332.

Moreover, in the side-surface outer electrode 4, the thickness of the thickest portion of the second convex portion 433 is less than the thickness of the thickest portion of the first convex portion 432.

Because the second convex portions 333 and 433 are located closer than the concave portions 331 and 431 to the bent edge portions 32a and 42a, it is conceivable that stress of the second convex portion 333 and 433 is comparatively easily transmitted to the bent edge portions 32a and 42a even when the concave portions 331 and 431 are provided in the underlying electrode layers 33 and 43. However, with the above configuration, it is possible to reduce stress of the second convex portions 333 and 433 by reducing the thickness of the second convex portions 333 and 433. Thus, because it is possible to reduce transmission of stress to the bent edge portions 32a and 42a, it is possible to more effectively reduce or prevent breakage of the multilayer body 2.

In the present example embodiment, in the end-surface outer electrode 3, the concave portion 331 is provided at a position such that the separation distance from an end portion of the bent portion 32 in the electrode separation direction D12 is in the range of about ½e to about 9/10e, where e is the dimension of the bent portion 32 in the electrode arrangement direction D1, for example, within manufacturing and measurement tolerances.

Moreover, in the side-surface outer electrodes 4, the concave portion 431 is provided at a position such that the separation distance from an end portion of the bent portion 42 in the electrode separation direction D22 is in the range of about ½e to about 9/10e, where e is the dimension of the bent portion 42 in the electrode arrangement direction D2, for example, within manufacturing and measurement tolerances.

With the above configuration, while stress in portions of the bent portions 32 and 42 that are in the electrode separation direction relative to the concave portions 331 and 431 is not easily transmitted to portions that are closer than the bent edge portions 32a and 42a to the concave portions 331 and 431, in the bent portions 32 and 42, it is possible to make the positions of the concave portion 331 and 431 close to the bent edge portions 32a and 42a. Therefore, it is possible to allow the concave portions 331 and 431 to receive a larger proportion of the stress of the entirety of the bent portions 32 and 42. Thus, it is possible to more effectively reduce or prevent transmission of stress to the bent edge portions 32a and 42a.

In the present example embodiment, in the end-surface outer electrode 3, the thickness of the concave portion 331 of the end-surface outer electrode 3 is greater than or equal to about 0.5 μm, for example, within manufacturing and measurement tolerances.

Moreover, in the side-surface outer electrode 4, the thickness of the concave portion 431 of the side-surface outer electrode 4 is greater than or equal to about 0.5 μm, for example, within manufacturing and measurement tolerances.

While it is conceivable that stress concentrates on the concave portions 331 and 431 comparatively easily, with the above configuration, it is possible to ensure the strength of the concave portions 331 and 431. Accordingly, in the outer electrodes 3 and 4, it is possible to ensure the strength of the bent portions 32 and 42.

In the present example embodiment, in the end-surface outer electrode 3, the thickness of the first convex portion 332 is less than or equal to about 75 μm, for example, within manufacturing and measurement tolerances.

In the side-surface outer electrode 4, the thickness of the first convex portion 432 is less than or equal to about 75 μm, for example, within manufacturing and measurement tolerances.

With the above configuration, because it is possible to make the thickness of the bent portions 32 and 42 comparatively small, it is possible to reduce or prevent increase in the height of the multilayer ceramic capacitor 1.

Heretofore, example embodiments of the present invention have been described. However, the present invention is not limited to the example embodiments described above and can be changed and modified in various ways.

In the example embodiments described above, the outer surfaces of the bent portion 32 of the end-surface outer electrode 3 and the bent portion 42 of the side-surface outer electrode 4 each have a concave/convex shape. However, the outer surface of one of the bent portion 32 and the bent portion 42 may be a flat surface. In the multilayer body 2, the dimension of the inner electrode 15 in the width direction W is smaller than the dimension of the inner electrode 15 in the length direction L. Therefore, the mechanical strength of the multilayer ceramic capacitor 1 in the width direction W is lower than the mechanical strength of the multilayer ceramic capacitor 1 in the length direction L. For this reason, when a concave/convex shape is to be provided in one of the underlying electrode layer 33 of the end-surface outer electrode 3 and the underlying electrode layer 43 of the side-surface outer electrode 4, it is preferable that the concave/convex shape be provided in the underlying electrode layer 43 of the side-surface bent portion 32B. Thus, it is easy to ensure the strength of the multilayer ceramic capacitor 1.

In the example embodiments described above, the underlying electrode layer 33 of the end-surface outer electrode 3 has a shape such that a portion thereof disposed on each main surface A and a portion thereof disposed on each side surface B have substantially corresponding shapes. However, the shapes of these portions need not be corresponding shapes. For example, in the example embodiments described above, in the underlying electrode layer 33, the outer surfaces of the main-surface bent portion 32A and the side-surface bent portion 32B each have a concave/convex shape. However, it is not necessary that both of the main-surface bent portion 32A and the side-surface bent portion 32B have the concave/convex shape of the example embodiments described above. When the multilayer ceramic capacitor 1 is a three-terminal multilayer ceramic capacitor, because the multilayer ceramic capacitor 1 is mounted on a mounting board so that the main surface A faces the mounting board, it is preferable that at least the main-surface bent portion 32A have the concave/convex shape of the example embodiments described above.

In the example embodiments described above, in the underlying electrode layer 33 of the end-surface outer electrode 3, a portion disposed on the first main surface AA and a portion disposed on the second main surface AB each have a concave/convex shape. However, it is not necessary that both of the main surfaces A have the concave/convex shape of the example embodiments described above. The configuration in the example embodiments described above is preferable because desirable advantageous effects can be obtained regardless of which of the main surfaces A faces the mounting board when the multilayer ceramic capacitor 1 is mounted on a mounting board.

In the example embodiments described above, the outer electrodes 3 and 4 respectively include the first plating layers 35 and 45 and the second plating layers 36 and 46. However, the first plating layers 35 and 45 and the second plating layers 36 and 46 may be omitted. When the first plating layers 35 and 45 and the second plating layers 36 and 46 are not provided in the outer electrodes 3 and 4, the outer surfaces of the outer electrodes 3 and 4 are the outer surfaces of the underlying electrode layers 33 and 43.

In the example embodiments described above, the outer electrodes 3 and 4 are the outer electrodes the multilayer ceramic capacitor 1 of a three-terminal type. However, this is not a limitation. For example, in a multilayer ceramic capacitor (so-called two-terminal multilayer ceramic capacitor) including a multilayer body and a pair of outer electrodes that are provided on either of side surfaces or end surfaces of the multilayer body, the multilayer body including inner electrodes that are connected to only one of the pair of outer electrodes and inner electrodes that are connected to only the other of the pair of outer electrodes, an underlying electrode layer of each of the outer electrodes may have a concave/convex shape corresponding to that of the example embodiments described above. The structure of the inside of the multilayer body (such as the shapes and the like of the inner electrodes) is not particularly limited.

In the case of the two-terminal multilayer ceramic capacitor, when the multilayer ceramic capacitor is mounted on a mounting board, not only the main surface A but also the side surface B can become a surface on the mounting board side. Therefore, in the case of the two-terminal multilayer ceramic capacitor, it is preferable that, in both of the bent portion on the main surface A and the bent portion on the side surface B, the underlying electrode layer have a concave/convex shape corresponding to that of the example embodiments described above. Thus, with the two-terminal multilayer ceramic capacitor, it is possible to obtain desirable advantageous effects irrespective of the direction of the multilayer ceramic capacitor when mounted.

In the example embodiments described above, the outer electrodes 3 and 4 include the first plating layers 35 and 45 and the second plating layers 36 and 46. However, the structure of the plating layer is not limited to the two-layer structure. The type of a metal included in the plating layer is not limited to that in the example embodiments described above. The configuration of the plating layer of the outer electrode is not particularly limited, as long as the outer surface of the outer electrode has a shape substantially the same as that of the outer shape of the underlying electrode layer.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including an inner layer portion including a plurality of dielectric layers and a plurality of inner electrodes, a first main surface and a second main surface facing each other in a stacking direction, a first side surface and a second side surface facing each other in a width direction perpendicular to the stacking direction, and a first end surface and a second end surface facing each other in a length direction perpendicular to the stacking direction and the width direction; and
a pair of outer electrodes on at least either of the side surfaces or the end surfaces; wherein
when an electrode arrangement direction is defined as a direction in which the pair of outer electrodes are arranged, and, in the electrode arrangement direction, an electrode proximity direction is defined as a direction in which the pair of outer electrodes are in proximity to each other and an electrode separation direction is defined as a direction in which the pair of outer electrodes are separated from each other:
each of the outer electrodes includes a connection portion on a corresponding one of the side surfaces and the end surfaces that face each other in the electrode arrangement direction, and a bent portion that extends from the connection portion in the electrode proximity direction;
the bent portion includes an underlying electrode layer including Cu; and
the underlying electrode layer of the bent portion includes a concave portion where a thickness of the underlying electrode layer is less than a thickness of a portion of the underlying electrode layer that is adjacent in the electrode proximity direction and is less than or equal to a thickness of a portion of the underlying electrode layer that is adjacent in the electrode separation direction, a first convex portion that is a portion of the underlying electrode layer of the bent portion that is on an electrode separation direction side relative to the concave portion, and a second convex portion that is a portion of the underlying electrode layer of the bent portion that is on an electrode proximity direction side relative to the concave portion.

2. The multilayer ceramic capacitor according to claim 1, wherein a thickness of the concave portion is less than or equal to about ¾ of a thickness of a thickest portion of the first convex portion.

3. The multilayer ceramic capacitor according to claim 1, wherein a thickness of a thickest portion of the second convex portion is less than a thickness of a thickest portion of the first convex portion.

4. The multilayer ceramic capacitor according to claim 1, wherein the concave portion is provided at a position such that a separation distance from an end portion of the bent portion in the electrode separation direction is in a range of about ½e to about 9/10e, where e is a dimension of the underlying electrode layer of the bent portion in the electrode arrangement direction.

5. The multilayer ceramic capacitor according to claim 1, wherein a thickness of the concave portion is greater than or equal to about 0.5 μm.

6. The multilayer ceramic capacitor according to claim 1, wherein a thickness of the first convex portion is less than or equal to about 75 μm.

7. The multilayer ceramic capacitor according to claim 1, wherein the multilayer ceramic capacitor is a two terminal capacitor or a three terminal capacitor.

8. The multilayer ceramic capacitor according to claim 1, wherein the bent portion includes a first plating layer and a second plating layer.

9. The multilayer ceramic capacitor according to claim 1, wherein the underlying electrode layer further includes glass.

10. The multilayer ceramic capacitor according to claim 1, wherein the pair of outer electrodes include a first plating layer and a second plating layer.

11. The multilayer ceramic capacitor according to claim 1, wherein the first plating layer is a Ni plating layer and the second plating layer is a Sn plating layer.

12. The multilayer ceramic capacitor according to claim 1, wherein an outer surface of the underlying electrode layer of the bent portion has a convex/concave shape including two arcs that are convex in a direction away from the multilayer body.

13. The multilayer ceramic capacitor according to claim 1, wherein an outer surface of the first convex portion and an outer surface of the second convex portion each have an arc shape that is convex in a direction away from the multilayer body.

14. The multilayer ceramic capacitor according to claim 1, wherein the concave portion is a boundary portion between the first convex portion and the second convex portion.

15. The multilayer ceramic capacitor according to claim 1, wherein the second convex portion is located closer than the concave portion to an edge portion of the bent edge.

16. The multilayer ceramic capacitor according to claim 1, wherein outer surfaces of the bent portions of the outer electrodes each have a convex/concave shape or a flat surface.

17. The multilayer ceramic capacitor according to claim 16, wherein each of the plurality of inner electrodes has a dimension in the width direction that is smaller than a dimension in the length direction.

18. The multilayer ceramic capacitor according to claim 1, wherein a portion of the underlying electrode layer on the first main surface and a portion of the underlying electrode layer on the second main surface have substantially corresponding shapes.

19. The multilayer ceramic capacitor according to claim 1, wherein a portion of the underlying electrode layer on the first main surface and a portion of the underlying electrode layer on the second main surface each have a concave/convex shape.

20. The multilayer ceramic capacitor according to claim 1, wherein each of the pair of outer electrodes includes a first plating layer and a second plating layer.
